(19) United States
(12) Patent Application Publication
(10) Pub. No.: US 2008/0106071 A1
(43) Pub. Date: May 8, 2008

(54) Air venting assembly of air pump

(76) Inventor: Chien-Tien Huang, Taichung (TW)

Correspondence Address: Chien-Tien Huang, 235 Chung-Ho, Box 8-24, Taipei, omitted

(21) Appl. No.: 11/593,197

(22) Filed: Nov. 3, 2006

(51) Int. Cl. B60R 21/239

(52) U.S. Cl. 280/728.1

(57) ABSTRACT

An air venting assembly of an air pump comprises a venting film; at least one minor air guide holes being formed in the venting film; an airbag set having a driving block and an airbag; the driving block being driven by a motor; and the airbag having at least one air exhausting chamber; one end of the air exhausting chamber being an air inlet; and another end of the air exhausting chamber being sealed by the venting film; the driving block being installed in the air inlet; an air inlet hole being formed between the air inlet of the airbag and the air exhausting chamber; the air inlet hole being deformable. When the airbag set is driven by the motor, the air guide holes will expand. When the air inlet of the airbag inlets air, the air inlet hole will expand by the air pressure.

### FIELD OF THE INVENTION

The present invention relates to air pumps, and particularly to an air venting assembly of an air pump, wherein amount of air exhaust can be reduced.

### BACKGROUND OF THE INVENTION

In an air pump, a motor is used to compress and expand at least one airbag so as to achieve the object of auto-exhausting and auto-absorbing air.

In one prior art, an air exhausting device of an air pump has an isolation sheet and a venting film. The isolation sheet has at least one air outlet hole. The venting film has a plurality of elastic air exhausting blades. When the airbag compresses and exhausts air, the air exhausting blades will bend and open toward the direction of exhausting air by the extrusion of the air in the airbag. Thus air in the airbag can drain out from the air outlet hole. When the airbag expands for absorbing air, the blades will return to the original positions and thus closes the air outlet holes and thus to resist the airflows into the airbag from the air outlet hole. Similarly, as air inputs the airbag, the air inlet valve with blades are used to achieve the object of unidirectional flowing of the air.

In above mentioned prior art structure, the opening and closing operation of the air exhausting blades and air inlet valve will generate great noise. Thereby this will generate a great resistance so as to reduce the efficiency of air pumping. Thus the current must be increased so as to speed the rotation of the motor and thus has the defect of low efficiency of air pumping. Thus electric power is wasted. As a whole, the prior art is not a practical design and is necessary to be improved.

### SUMMARY OF THE INVENTION

Accordingly, the primary object of the present invention is to provide an air venting assembly of an air pump, wherein amount of air exhaust can be reduced.

To achieve above objects, the present invention provides an air venting assembly of an air pump which comprises a venting film; at least one minor air guide holes being formed in the venting film; an airbag set having a driving block and an airbag; the driving block being driven by a motor; and the airbag having at least one air exhausting chamber; one end of the air exhausting chamber being an air inlet; and another end of the air exhausting chamber being sealed by the venting film; the driving block being installed in the air inlet; an air inlet hole being formed between the air inlet of the airbag and the air exhausting chamber; the air inlet hole being deformable. When the airbag set is driven by the motor and thus the air exhausting chamber is compressed, the air guide holes will expand by the air pressure of air exhausted from the air exhausting chamber and when air is sucked to the air exhausting chamber, the air guide holes will reduced and sealed. When the air inlet of the airbag inlets air, the air inlet hole will expand by the air pressure; and when the airbag compresses, the air inlet hole will reduce and then close.

The various objects and advantages of the present invention will be more readily understood from the following detailed description when read in conjunction with the appended drawing.

### BRIEF DESCRIPTION OF THE DRAWINGS

FIG. 1 is an exploded perspective view of the air pump ventilation assembly of the present invention.

FIG. 1a is a schematic view about the isolation sheet and the venting film of the present invention.

FIG. 2 is an exploded perspective view showing the airbag of the air pump ventilation assembly of the present invention.

FIG. 3 is a schematic cross sectional view about the air pump ventilation assembly of the present invention.

FIG. 4 is a perspective view of the air pump ventilation assembly of the present invention.

FIG. 5 is a schematic cross sectional view showing the air venting of the air pump ventilation assembly of the present invention.

FIG. 5a is a partial enlarged schematic view showing the expansion of the air hole of the venting film of the present invention.

FIG. 6 is a schematic cross sectional view showing the air absorbing of the air pump ventilation assembly according to the present invention.

FIG. 6a is a partial enlarged schematic view about showing that the air guide holes of the venting film are reduced and than close according to the present invention.

FIG. 7 is an exploded perspective view of the second embodiment of the present invention.

FIG. 8 is a schematic cross sectional view about the air venting in the second embodiment of the present invention.

FIG. 8a is a schematic cross sectional view showing that the air guide holes expand according to the present invention.

FIG. 9 is a schematic cross sectional view about the second embodiment of the present invention.

FIG. 9a is a partial schematic view showing that the air guide hole of the venting film is reduced and then closes according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

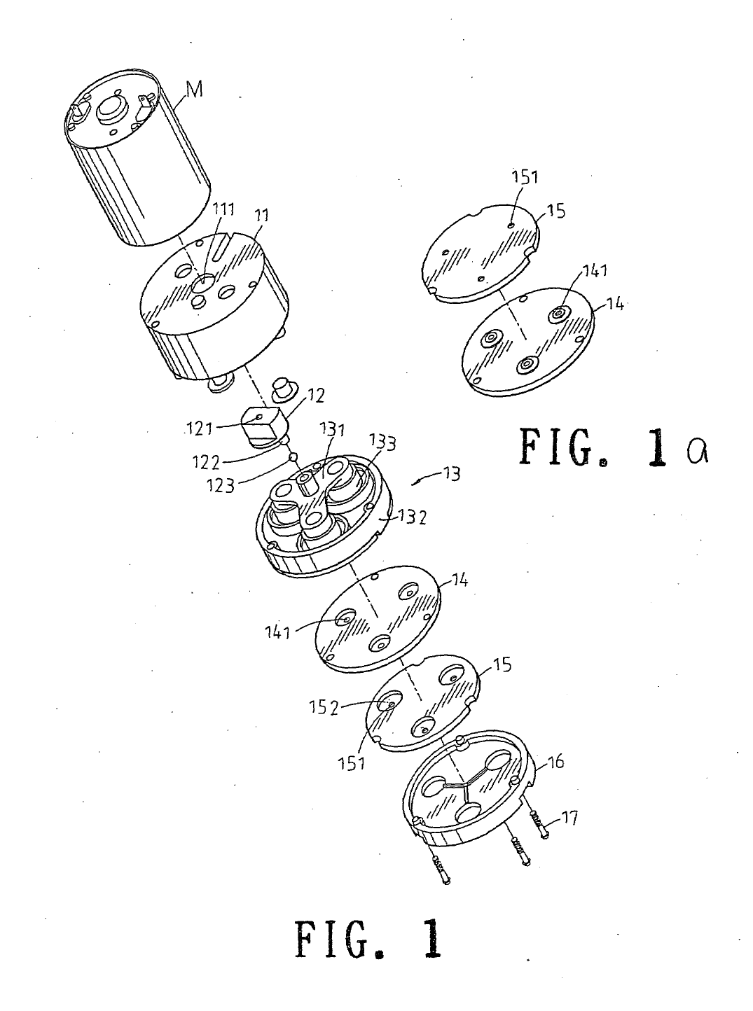

With reference to FIGS. 1 to 4, the structure of the present invention has the following elements.

A seat 11 has a through hole 111 axially arranged therein. The spindle M1 of a motor M can insert into the through hole 111.

A driving body 12 is received in the seat 11. One end of the driving body 12 has a positioning hole 121 capable of being combined with the spindle M1 of the motor M. Another end of the driving body 12 has an inclined driven rod 122. The driven rod 122 and a steel ball 123 can drive an airbag set 13 to move reciprocally for air venting and absorption.

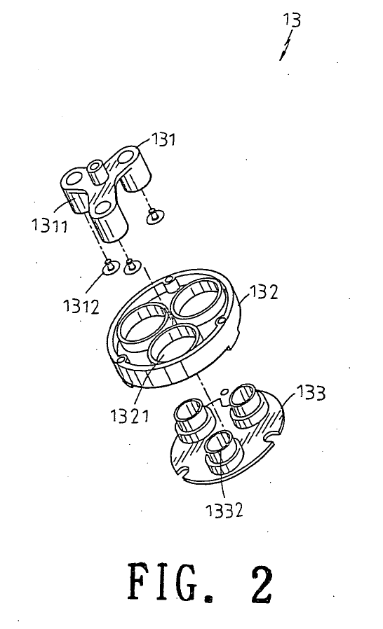

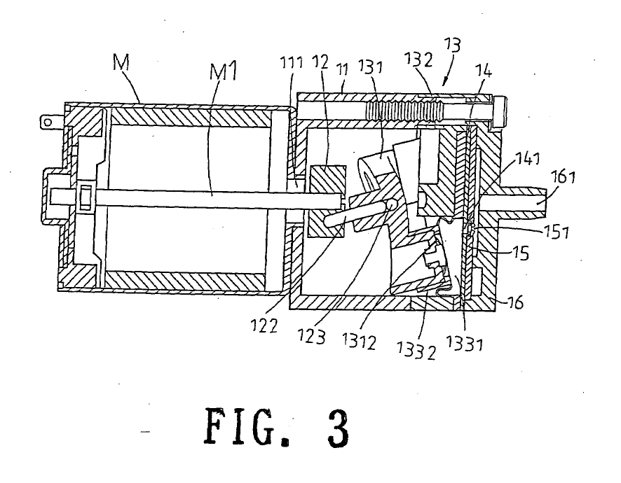

Referring to FIGS. 2 and 3, the airbag set 13 includes a driven block 131, a driven seat 132 and an airbag 133. In this embodiment, the driven block 131 has three bodies 1311. Each body 1311 has a hollow structure. One end of each body 1311 has an air inlet valve 1312 which is interacted with the airbag 133. The driven seat 132 is formed with a receiving groove 1321 for installing the airbag 133 and the driven seat 132. The driven seat 132 moves with the motor M. The airbag 133 is made of soft material. In this the present invention, the airbag 133 has three air exhausting chambers 1331. One end of each air exhausting chamber 1331 has an air inlet 1332 which are combined with the body 1311 of each driven block 131. Another end of the air exhausting chamber 1331 is adhered to an isolation sheet 14 and a venting film 15. The venting film 15 seals the air exhausting chamber 1331.

Referring to FIGS. 1, 1a and 3, the isolation sheet 14 and venting film 15 are illustrated.

The isolation sheet 14 is adhered to the airbag set 13. The isolation sheet 14 is formed with a plurality of via holes 141. The number of the via holes 141 is identical to that of the air exhausting chambers 1331. When the airbags 133 vent, air will flow to the via holes 141 to the venting film 15.

The venting film 15 is elastic and deformable. The venting film 15 is formed with a plurality of air guide holes 151. The number of the air guide holes 151 is identical to that of the air exhausting chambers 1331. A periphery of each air guide hole 151 is thinner than other portion of the venting film 15 so as to form with a round recess 152 for receiving a protruding portion of the via hole 151 of the isolation sheet 14. When air exhausts, the air guide hole 151 will be expanded by air so that air can vent out.

Referring to FIG. 3, an air vent cover 16 is illustrated. The cover 16 has an air outlet 161 for venting air.

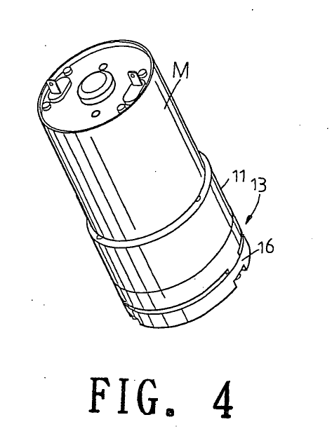

In assembly of the present invention, a plurality of screws 17 serve to combine the components. Referring to FIGS. 3 and 4, the assembly views of the present invention are shown. The airbag set 13 can rotate tiltly through the driving body 12 by the motor M. When the airbag set 13 rotates, the air exhausting chamber 1331 of each airbag 133 will compress and expand periodically. When the air exhausting chamber 1331 is compressed, air exhausts out from the air outlet 161 of the cover 16. One the contrary, when the air exhausting chamber 1331 expands, air flows in the air exhausting chamber 1331 from the air inlet 1332.

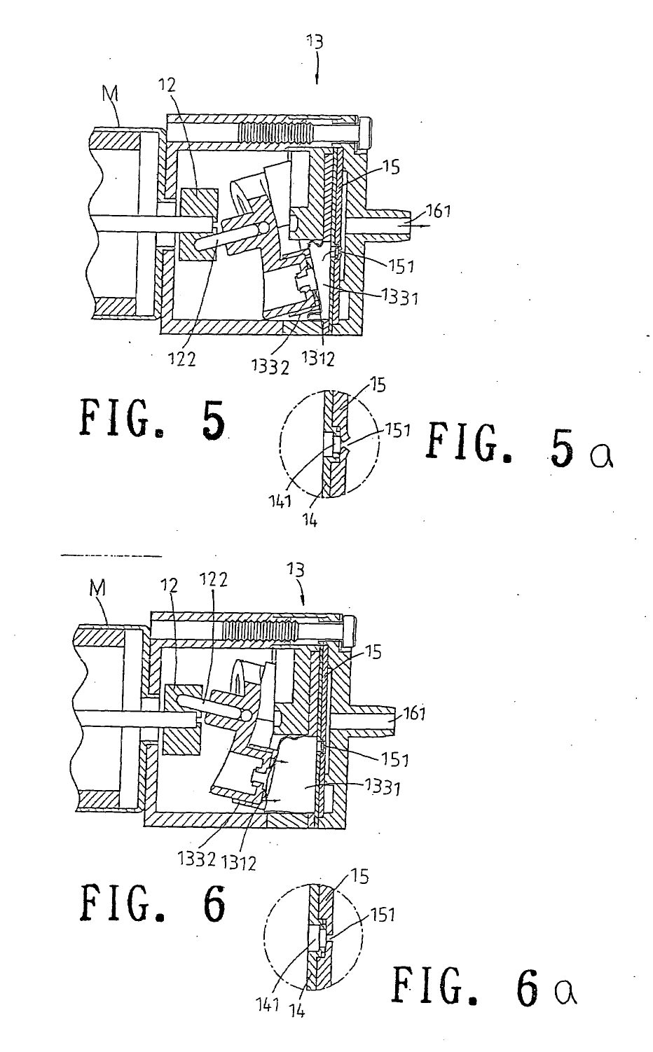

The operation of the present invention is illustrated in FIGS. 5, and 6, wherein the FIG. 5 shows that the air exhausting chamber 1331 is compressed by exhaustion and FIG. 6 shows that the air exhausting chamber 1331 is expanded for absorbing air.

When the motor M actuates to drive the airbag set 13 through the tilt driven rod 122 of the driving body 12, the air exhausting chamber 1331 in the airbag 133 will compress and expand cyclically.

With reference to FIG. 5, when the air exhausting chamber 1331 is compressed, the air pressure in the air exhausting chamber 1331 becomes greater. Then the air inlet valve 1312 of the air inlet 1332 of the airbag 133 and the air guide holes 151 of the venting film 15 will be extruded by the internal pressure of the air exhausting chamber 1331. When the air inlet valve 1312 is extruded by the air pressure of the air from the air exhausting chamber 1331, the air inlet 1332 will be sealed. When the air guide holes 151 is extruded by the air pressure of the air from the air exhausting chamber 1331, it is expanded, as shown in FIG. 5a and the thus the air guide holes 151 is compressed and then expanded. Then air in the air exhausting chamber 1331 will drain out from the air outlet 161.

Referring to FIG. 6, when the air exhausting chamber 1331 expands, the internal pressure of the air exhausting chamber 1331 becomes small. Thus the external air pressure out of the air exhausting chamber 1331 is greater than the internal air pressure of the air exhausting chamber 1331. The air inlet valve 1312 of the air inlet 1332 of the airbag 133 and the air guide holes 151 of the venting film 15 are pushed by the air pressure toward the air exhausting chamber 1331. The air inlet valve 1312 is opened toward the air exhausting chamber 1331. Thus air flows to the air inlet chamber and the air guide holes 151 will reduce by the pressure in the air exhausting chamber 1331 so that air can not pass therethrough.

By the venting film 15, the air exhausting chamber 1331 exhausts air unidirectionally from the air outlet 161. The air guide holes 151 of the venting film 15 expands for passing air and reduces for closing air path so as to avoid the venting film 15 to collide the isolation sheet 14 and thus no noise and resistance generate.

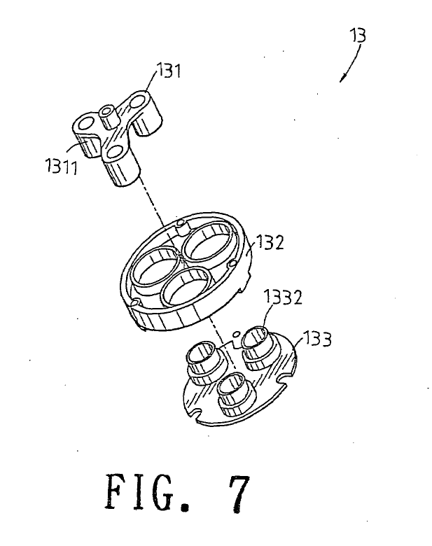

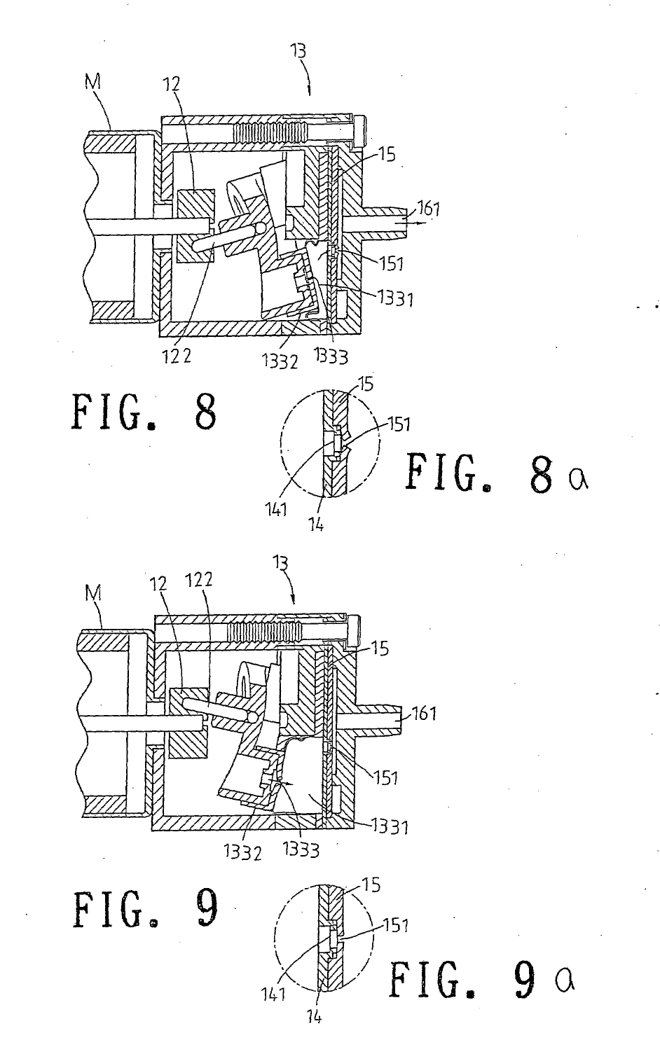

Referring to FIGS. 7 to 9, the second embodiment of the present invention is illustrated. Those identical to the above embodiment will not be further described. Only those difference is described herein.

In this embodiment, in the driven block 131, no air inlet valve is used. An air inlet hole 1333 is formed between the air inlet 1332 of the airbag 133 and the air exhausting chamber 1331. The air inlet hole 1333 is deformable. When the air inlet 1332 of the airbag 133 inlets air, the air inlet hole 1333 will expand by the air pressure. When the airbag 133 compresses, the air inlet hole 1333 will reduce and then close. Thus the same effect can be achieved.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An air venting assembly of an air pump comprising:
an airbag set being driven by a motor;
an venting film sealing the airbag set; the venting film being elastic and deformable; the venting film being formed with minor air guide holes; when the airbag set exhausts air, the air guide holes will expand by air pressure; and when airbag set sucks air, the air guide holes will compress.

2. The air venting assembly of an air pump as claimed in claim 1, wherein the airbag set comprise:
a driving block being driven by the motor; and
an airbag having at least one air exhausting chamber; the air exhausting chamber having an air inlet; the driven block being installed at the air inlet; an air inlet valve being installed between the air inlet and the air exhausting chamber; when air is sucked into the airbag, the air inlet valve will open and when air is exhausted, the air inlet valve will closed.

3. The air venting assembly of an air pump as claimed in claim 1, wherein the airbag set and the venting film are installed between a seat and an air exhausting cover; the seat has an through hole for receiving a spindle of a motor to drive the airbag; the air exhausting cover is formed with an air outlet for exhausting air.

4. The air venting assembly of an air pump as claimed in claim 1, wherein an isolation sheet is installed between the airbag set and the venting film; an via hole is formed in the isolation sheet; when airbag set exhausts air, the air will flow to the air guide holes of the venting film through the via hole.

5. The air venting assembly of an air pump as claimed in claim 2, wherein the air inlet valve is installed on the driving block.

6. The air venting assembly of an air pump as claimed in claim 4, wherein a periphery of each air guide hole is formed with a round groove; and the isolation sheet protrudes slightly toward the round groove.

7. An air venting assembly of an air pump comprising:
an airbag set being driven by a motor; an air inlet hole being formed between the air inlet of the airbag and the air exhausting chamber; the air inlet hole being deformable; when the air inlet of the airbag inlets air, the air inlet hole will expand by the air pressure; when the airbag compresses, the air inlet hole will reduce and then close.

8. An air venting assembly of an air pump comprising:
a venting film; at least one minor air guide holes being formed in the venting film;
an airbag set having a driving block and an airbag;
the driving block being driven by a motor; and the airbag having at least one air exhausting chamber; one end of the air exhausting chamber being an air inlet; and another end of the air exhausting chamber being sealed by the venting film;
the driving block being installed in the air inlet; an air inlet hole being formed between the air inlet of the airbag and the air exhausting chamber; the air inlet hole being deformable;
wherein when the airbag set is driven by the motor and thus the air exhausting chamber is compressed, the air guide holes will expand by the air pressure of air exhausted from the air exhausting chamber; when air is sucked to the air exhausting chamber, the air guide holes will reduced and sealed; when the air inlet of the airbag inlets air, the air inlet hole will expand by the air pressure; when the airbag compresses, the air inlet hole will reduce and then close.

9. The air venting assembly of an air pump as claimed in claim 8, wherein the airbag set and the venting film are installed between a seat and an air exhausting cover; the seat has an through hole for receiving a spindle of a motor to drive the airbag; the air exhausting cover is formed with an air outlet for exhausting air.

10. The air venting assembly of an air pump as claimed in claim 8, wherein an isolation sheet is installed between the airbag set and the venting film; an via hole is formed in the isolation sheet; when airbag set exhausts air, the air will flow to the air guide holes of the venting film through the via hole.

11. The air venting assembly of an air pump as claimed in claim 10, wherein a periphery of each air guide hole is formed with a round groove; and the isolation sheet protrudes slightly toward the round groove.
